(19) United States
(12) Patent Application Publication
(10) Pub. No.: US 2013/0086523 A1
(43) Pub. Date: Apr. 4, 2013

(54) DEVICE, METHOD, AND STORAGE MEDIUM STORING PROGRAM

(71) Applicant: KYOCERA CORPORATION, Kyoto-shi (JP)

(72) Inventor: Motonori IMAMURA, Yokohama-shi (JP)

(73) Assignee: KYOCERA CORPORATION, Kyoto-shi (JP)

(21) Appl. No.: 13/633,964

(22) Filed: Oct. 3, 2012

(30) Foreign Application Priority Data
Oct. 3, 2011 (JP) 2011-219532

(51) Int. Cl. G06F 3/048

(52) U.S. Cl. 715/810

(57) ABSTRACT

According to an aspect, a device includes a display and a controller. The display displays a home screen in which an icon corresponding to an application to be executed in foreground or background is arranged. The controller controls the display such that the icon corresponding to the application executed in the background is displayed in a first mode and the icon corresponding to the application not executed in the background is displayed in a second mode.

### CROSS-REFERENCE TO RELATED APPLICATIONS

This application claims priority from Japanese Application No. 2011-219532, filed on Oct. 3, 2011, the content of which is incorporated by reference herein in its entirety.

### BACKGROUND

1. Technical Field

The present invention relates to a device, a method, and a storage medium storing therein a program. More particularly, the present invention relates to a device executing an application in the foreground or in the background, a method of controlling the device, and a storage medium storing a program for controlling the device.

2. Description of the Related Art

A known device displays icons on a display, and executes the application corresponding to the icons in accordance with the gesture for the icons (For example, WO 2008/086302). The basic operations of this device are realized based on an operating system (OS) built into the device. Examples of the OS built into the device include, but are not limited to, Android, BlackBerry OS, iOS, Symbian OS, and Windows Phone.

Some devices that display icons execute the application in the foreground or in the background. For the foregoing reasons, there is a need for a device, a method, and a program that that allow the user to easily perform an operation for the application executed in the background.

### SUMMARY

According to an aspect, a device includes a display and a controller. The display displays a home screen in which an icon corresponding to an application to be executed in foreground or background is arranged. The controller controls the display such that the icon corresponding to the application executed in the background is displayed in a first mode and the icon corresponding to the application not executed in the background is displayed in a second mode.

According to another aspect, a method is for controlling a device including a display. The method includes: executing an application in foreground or background; displaying an icon corresponding to the application executed in the background on the display in a first mode; and displaying an icon corresponding to the application not executed in the background on the display in a second mode.

According to another aspect, a non-transitory storage medium stores therein a program. When executed by a device including a display, the program causes the device to execute: executing an application in foreground or background; displaying an icon corresponding to the application executed in the background on the display in a first mode; and displaying an icon corresponding to the application not executed in the background on the display in a second mode.

### BRIEF DESCRIPTION OF THE DRAWINGS

FIG. 1 is a perspective view of a smartphone according to an embodiment;

FIG. 2 is a front view of the smartphone;

FIG. 3 is a back view of the smartphone;

FIG. 4 is a diagram illustrating an example of a home screen;

FIG. 5 is a block diagram of the smartphone;

FIG. 6 is a diagram illustrating an example in which the application is controlled to be executed in the background;

FIG. 7 is a diagram illustrating an example of the control for the application being executed in the background;

FIG. 8 is a flowchart illustrating procedures of an icon display process;

FIG. 9 is a flowchart illustrating procedures of an application control process;

FIG. 10 is a diagram illustrating another example of an icon display mode; and

FIG. 11 is a diagram illustrating still another example of an icon display mode.

### DETAILED DESCRIPTION

Exemplary embodiments of the present invention will be explained in detail below with reference to the accompanying drawings. A smartphone will be explained below as an example of a device provided with a touch screen display.

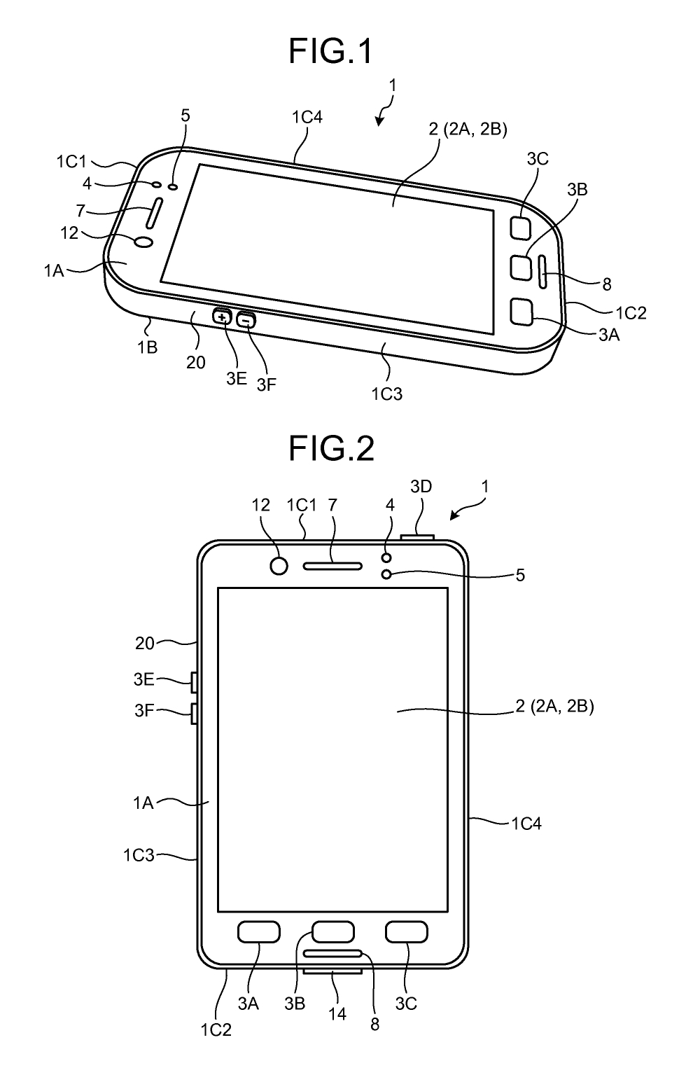

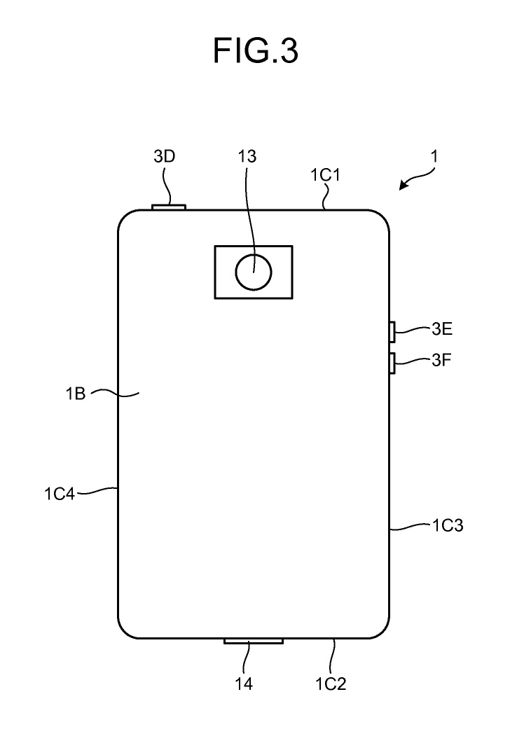

An overall configuration of a smartphone 1 according to an embodiment will be explained below with reference to FIG. 1 to FIG. 3. As illustrated in FIG. 1 to FIG. 3, the smartphone 1 includes a housing 20. The housing 20 includes a front face 1A, a back face 1B, and side faces 1C1 to 1C4. The front face 1A is a front of the housing 20. The back face 1B is a back of the housing 20. The side faces 1C1 to 1C4 are sides each connecting the front face 1A and the back face 1B. Hereinafter, the side faces 1C1 to 1C4 may be collectively called “side face 1C” without being specific to any of the side faces.

The smartphone 1 includes a touch screen display 2, buttons 3A to 3C, an illumination (ambient light) sensor 4, a proximity sensor 5, a receiver 7, a microphone 8, and a camera 12, which are provided in the front face 1A. The smartphone 1 includes a camera 13, which is provided in the back face 1B. The smartphone 1 includes buttons 3D to 3F and a connector 14, which are provided in the side face 1C. Hereinafter, the buttons 3A to 3F may be collectively called “button 3” without being specific to any of the buttons.

The touch screen display 2 includes a display 2A and a touch screen 2B. In the example of FIG. 1, each of the display 2A and the touch screen 2B is approximately rectangular-shaped; however, the shapes of the display 2A and the touch screen 2B are not limited thereto. Each of the display 2A and the touch screen 2B may have any shape such as a square, a circle or the like. In the example of FIG. 1, the display 2A and the touch screen 2B are arranged in a superimposed manner; however, the manner in which the display 2A and the touch screen 2B are arranged is not limited thereto. The display 2A and the touch screen 2B may be arranged, for example, side by side or apart from each other. In the example of FIG. 1, longer sides of the display 2A are along with longer sides of the touch screen 2B respectively while shorter sides of the display 2A are along with shorter sides of the touch screen 2B respectively; however, the manner in which the display 2A and the touch screen 2B are superimposed is not limited thereto. In case the display 2A and the touch screen 2B are arranged in the superimposed manner, they can be arranged such that, for example, one or more sides of the display 2A are not along with any sides of the touch screen 2B.

The display 2A is provided with a display device such as a liquid crystal display (LCD), an organic electro-luminescence display (GELD), or an inorganic electro-luminescence display (IELD). The display 2A displays text, images, symbols, graphics, and the like.

The touch screen 2B detects a contact of a finger, a pen, a stylus pen, or the like on the touch screen 2B. The touch screen 2B can detect positions where a plurality of fingers, pens, stylus pens, or the like make contact with the touch screen 2B. In the description herein below, a finger, pen, stylus pen, and the like may be referred to as a “contact object” or an “object”.

The detection method of the touch screen 2B may be any detection methods, including but not limited to, a capacitive type detection method, a resistive type detection method, a surface acoustic wave type (or ultrasonic type) detection method, an infrared type detection method, an electro magnetic induction type detection method, and a load sensing type detection method. In the description herein below, for the sake of simplicity, it is assumed that the user uses his/her finger(s) to make contact with the touch screen 2B in order to operate the smartphone 1.

The smartphone 1 determines a type of a gesture based on at least one of a contact detected by the touch screen 2B, a position where the contact is detected, a change of a position where the contact is detected, an interval between detected contacts, and the number of detection times of the contact. The gesture is an operation performed on the touch screen 2B. Examples of the gestures determined by the smartphone 1 include, but are not limited to, touch, long touch, release, swipe, tap, double tap, long tap, drag, flick, pinch in, and pinch out.

“Touch” is a gesture in which a finger makes contact with the touch screen 2B. The smartphone 1 determines a gesture in which the finger makes contact with the touch screen 2B as touch. “Long touch” is a gesture in which a finger makes contact with the touch screen 2B for longer than a given time. The smartphone 1 determines a gesture in which the finger makes contact with the touch screen 2B for longer than a given time as long touch.

“Release” is a gesture in which a finger separates from the touch screen 2B. The smartphone 1 determines a gesture in which the finger separates from the touch screen 2B as release. “Swipe” is a gesture in which a finger moves on the touch screen 2B with continuous contact thereon. The smartphone 1 determines a gesture in which the finger moves on the touch screen 2B with continuous contact thereon as swipe.

“Tap” is a gesture in which a touch is followed by a release. The smartphone 1 determines a gesture in which a touch is followed by a release as tap. “Double tap” is a gesture such that a gesture in which a touch is followed by a release is successively performed twice. The smartphone 1 determines a gesture such that a gesture in which a touch is followed by a release is successively performed twice as double tap.

“Long tap” is a gesture in which a long touch is followed by a release. The smartphone 1 determines a gesture in which a long touch is followed by a release as long tap. “Drag” is a gesture in which a swipe is performed from an area where a movable-object is displayed. The smartphone 1 determines a gesture in which a swipe is performed from an area where the movable-object displayed as drag.

“Flick” is a gesture in which a finger separates from the touch screen 2B while moving after making contact with the touch screen 2B. That is, “Flick” is a gesture in which a touch is followed by a release accompanied with a movement of the finger. The smartphone 1 determines a gesture in which the finger separates from the touch screen 2B while moving after making contact with the touch screen 2B as flick. The flick is performed, in many cases, with a finger moving along one direction. The flick includes “upward flick” in which the finger moves upward on the screen, “downward flick” in which the finger moves downward on the screen, “rightward flick” in which the finger moves rightward on the screen, and “leftward flick” in which the finger moves leftward on the screen, and the like. Movement of the finger during the flick is, in many cases, quicker than that of the finger during the swipe.

“Pinch in” is a gesture in which a swipe with a plurality of fingers is performed in a direction to move the fingers toward each other. The smartphone 1 determines a gesture in which the distance between a position of one finger and a position of another finger detected by the touch screen 2B becomes shorter as pinch in. “Pinch out” is a gesture in which a swipe with a plurality of fingers is performed in a direction to move the fingers away from each other. The smartphone 1 determines a gesture in which the distance between a position of one finger and a position of another finger detected by the touch screen 2B becomes longer as pinch out.

In the description herein below, a gesture performed by using a finger may be referred to as a “single touch gesture”, and a gesture performed by using a plurality of fingers may be referred to as a “multi touch gesture”. Examples of the multi touch gesture include a pinch in and a pinch out. A tap, a flick, a swipe, and the like are a single touch gesture when performed by using a finger, and are a multi touch gesture when performed by using a plurality of fingers.

The smartphone 1 performs operations according to these gestures which are determined through the touch screen 2B. Therefore, user-friendly and intuitive operability is achieved. The operations performed by the smartphone 1 according to the determined gestures may be different depending on the screen displayed on the display 2A. In the following explanation, for the sake of simplicity of explanation, the fact that the touch screen detects the contact(s) and then the smartphone determines the type of the gesture as X based on the contact(s) may be simply described as “the smartphone detects X” or “the controller detects X”.

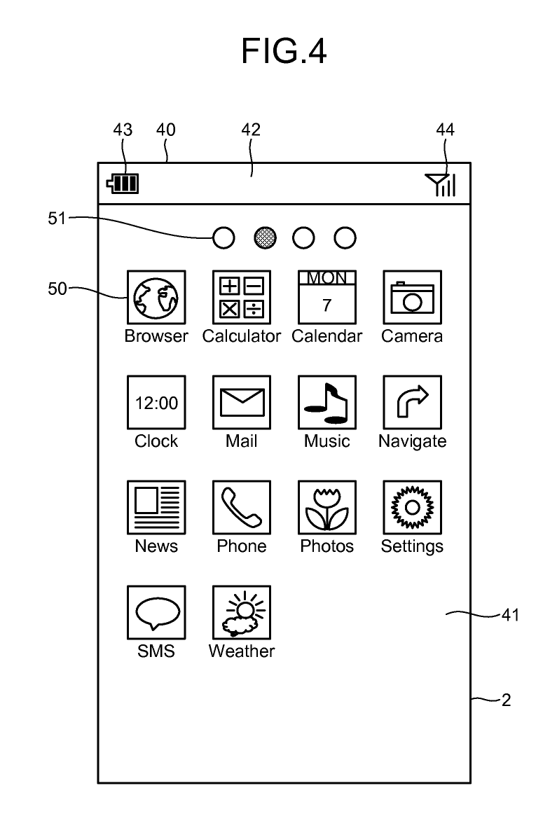

An example of the screen displayed on the display 2A will be explained below with reference to FIG. 4. FIG. 4 represents an example of a home screen. The home screen may also be called “desktop”, “standby screen”, “idle screen”, or “standard screen”. The home screen is displayed on the display 2A. The home screen is a screen allowing the user to select which one of applications (programs) installed in the smartphone 1 is executed. The smartphone 1 executes the application selected on the home screen in the foreground. The screen of the application executed in the foreground is displayed on the display 2A.

Icons can be arranged on the home screen of the smartphone 1. A plurality of icons 50 are arranged on a home screen 40 illustrated in FIG. 4. Each of the icons 50 is previously associated with an application installed in the smartphone 1. When detecting a gesture for an icon 50, the smartphone 1 executes the application associated with the icon 50 for which the gesture is detected. For example, when detecting a tap on an icon 50 associated with a mail application, the smartphone 1 executes the mail application.

The icons 50 include an image and a character string. The icons 50 may contain a symbol or a graphic instead of an image. The icons 50 do not have to include either one of the image and the character string. The icons 50 are arranged based on a layout pattern. A wall paper 41 is displayed behind the icons 50. The wall paper may sometimes be called “photo screen”, “back screen”, “idle image”, or “background image”. The smartphone 1 can use an arbitrary image as the wall paper 41. The smartphone 1 may be configured so that the user can select an image to be displayed as the wall paper 41.

The smartphone 1 can include a plurality of home screens. The smartphone 1 determines, for example, the number of home screens according to setting by the user. The smartphone 1 displays a selected one on the display 2A even if there is a plurality of home screens.

The smartphone 1 displays an indicator (a locator) 51 on the home screen. The indicator 51 includes one or more symbols. The number of the symbols is the same as that of the home screens. In the indicator 51, a symbol corresponding to a home screen that is currently displayed is displayed in a different manner from that of symbols corresponding to the other home screens.

The indicator 51 in an example illustrated in FIG. 4 includes four symbols. This means the number of home screens is four. According to the indicator 51 in the example illustrated in FIG. 4, the second symbol from the left is displayed in a different manner from that of the other symbols. This means that the second home screen from the left is currently displayed.

The smartphone 1 can change a home screen to be displayed on the display 2A. When a gesture is detected while displaying one of home screens, the smartphone 1 changes the home screen to be displayed on the display 2A to another one. For example, when detecting a rightward flick, the smartphone 1 changes the home screen to be displayed on the display 2A to a home screen on the left side. For example, when detecting a leftward flick, the smartphone 1 changes the home screen to be displayed on the display 2A to a home screen on the right side. The smartphone 1 changes the home screen to be displayed on the display 2A from a first home screen to a second home screen, when a gesture is detected while displaying the first home screen, such that the area of the first home screen displayed on the display 2A gradually becomes smaller and the area of the second home screen displayed gradually becomes larger. The smartphone 1 may switch the home screens such that the first home screen is instantly replaced by the second home screen.

An area 42 is provided along the top edge of the display 2A. Displayed on the area 42 are a remaining mark 43 indicating a remaining amount of a power supply and a radio-wave level mark 44 indicating an electric field strength of radio wave for communication. The smartphone 1 may display time, weather, an application during execution thereof, a type of communication system, a status of a phone call, a mode of the device, an event occurring in the device, and the like in the area 42. In this manner, the area 42 is used to inform the user of various notifications. The area 42 may be provided on any screen other than the home screen 40. A position where the area 42 is provided is not limited to the top edge of the display 2A.

The home screen 40 illustrated in FIG. 4 is only an example, and therefore the configuration of each of elements, the arrangement of the elements, the number of home screens 40, the way to perform each of operations on the home screen 40, and the like do not have to be like the above mentioned explanation.

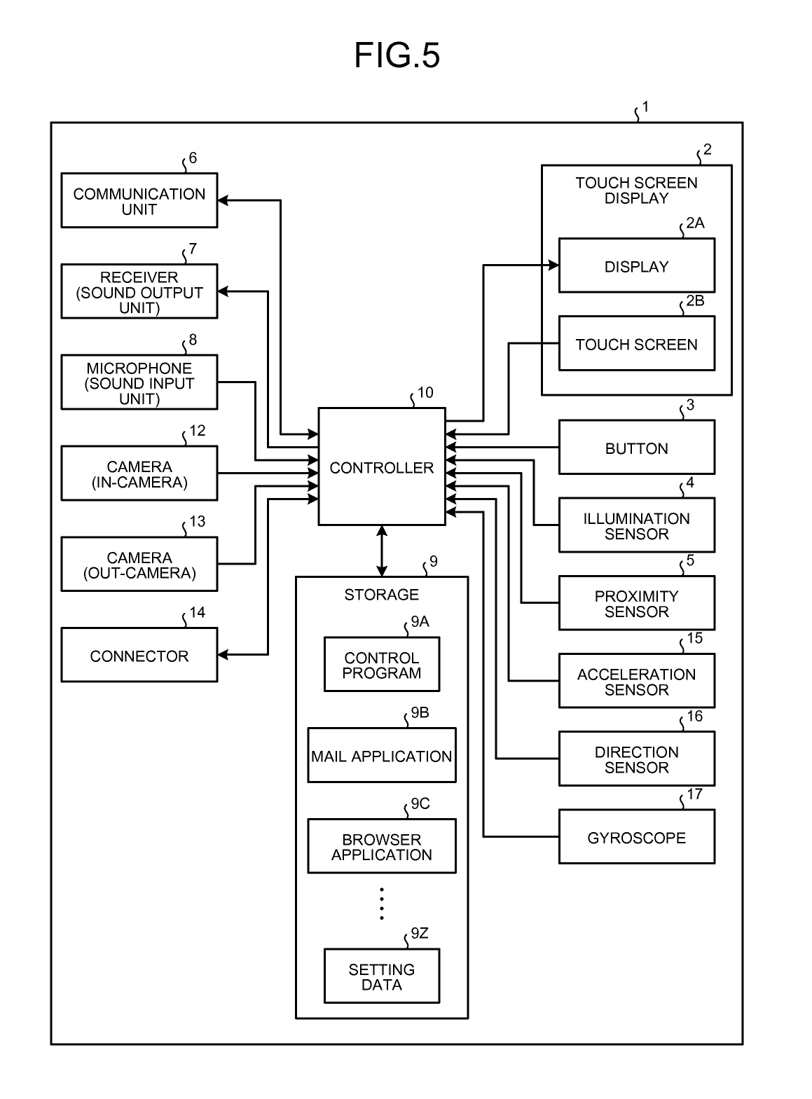

FIG. 5 is a block diagram of the smartphone 1. The smartphone 1 includes the touch screen display 2, the button 3, the illumination sensor 4, the proximity sensor 5, a communication unit 6, the receiver 7, the microphone 8, a storage 9, a controller 10, the cameras 12 and 13, the connector 14, an acceleration sensor 15, a direction (orientation) sensor 16, and a gyroscope 17.

The touch screen display 2 includes, as explained above, the display 2A and the touch screen 2B. The display 2A displays text, images, symbols, graphics, or the like. The touch screen 2B detects contact(s). The controller 10 detects a gesture performed for the smartphone 1. Specifically, the controller 10 detects an operation (a gesture) for the touch screen 2B in cooperation with the touch screen 2B.

The button 3 is operated by the user. The button 3 includes buttons 3A to 3F. The controller 10 detects an operation for the button 3 in cooperation with the button 3. Examples of the operations for the button 3 include, but are not limited to, a click, a double click, a triple click, a push, and a multi-push.

The buttons 3A to 3C are, for example, a home button, a back button, or a menu button. The button 3D is, for example, a power on/off button of the smartphone 1. The button 3D may function also as a sleep/sleep release button. The buttons 3E and 3F are, for example, volume buttons.

The illumination sensor 4 detects illumination of the ambient light of the smartphone 1. The illumination indicates intensity of light, lightness, or brightness. The illumination sensor 4 is used, for example, to adjust the brightness of the display 2A. The proximity sensor 5 detects the presence of a nearby object without any physical contact. The proximity sensor 5 detects the presence of the object based on a change of the magnetic field, a change of the return time of the reflected ultrasonic wave, etc. The proximity sensor 5 detects that, for example, the touch screen display 2 is brought close to someone's face. The illumination sensor 4 and the proximity sensor 5 may be configured as one sensor. The illumination sensor 4 can be used as a proximity sensor.

The communication unit 6 performs communication via radio waves. A communication system supported by the communication unit 6 is wireless communication standard. The wireless communication standard includes, for example, a communication standard of cellar phones such as 2G, 3G, and 4G. The communication standard of cellar phones includes, for example, Long Term Evolution (LTE), Wideband Code Division Multiple Access (W-CDMA), CDMA 2000, a Personal Digital Cellular (PDC), a Global System for Mobile Communications (GSM), and a Personal Handy-phone System (PHS). The wireless communication standard further includes, for example, Worldwide Interoperability for Microwave Access (WiMAX), IEEE 802.11, Bluetooth, Infrared Data Association (IrDA), and Near Field Communication (NFC). The communication unit 6 may support one or more communication standards.

The receiver 7 is a sound output unit. The receiver 7 outputs a sound signal transmitted from the controller 10 as sound. The receiver 7 is used, for example, to output voice of the other party on the phone. The microphone 8 is a sound input unit. The microphone 8 converts speech of the user or the like to a sound signal and transmit the converted signal to the controller 10. The smartphone 1 may be provided with a speaker instead of, or in addition to, the receiver 7.

The storage 9 stores therein programs and data. The storage 9 is used also as a work area that temporarily stores a processing result of the controller 10. The storage 9 may include any non-transitory storage medium such as a semiconductor storage medium and a magnetic storage medium. The storage 9 may include a plurality type of storage mediums. The storage 9 may include a combination of a portable storage medium such as a memory card, an optical disc, or a magneto-optical disc with a reader of the storage medium. The storage 9 may include a storage device used as a temporary storage area such as Random Access Memory (RAM).

The programs stored in the storage 9 include applications executed in the foreground or in the background and a control program for assisting operations of the applications. The application causes, for example, a predetermined screen to be displayed on the display 2A, and the controller to perform a process according to a gesture detected through the touch screen 2B. The control program is, for example, an OS. The application and the control program may be installed in the storage 9 through communication by the communication unit 6 or through a non-transitory storage medium.

The storage 9 stores, for example, a control program 9A, a mail application 9B, a browser application 9C, and setting data 9Z. The mail application 9B provides several email functions for composing, transmitting, receiving, and displaying e-mails, and the like. The browser application 9C provides Web browsing functions for displaying Web pages. The setting data 9Z provides various setting functions regarding operations of the smartphone 1.

The control program 9A provides a function regarding various controls for operating the smartphone 1. The control program 9A controls, for example, the communication unit 6, the receiver 7, and the microphone 8 to make a phone call. The function provided by the control program 9A includes a function for performing various controls, such as for changing information displayed on the display 2A in accordance with the gesture detected through the touch screen 2B. The function provided by the control program 9A can be used in combination with a function provided by the other program such as the mail application 9B.

The controller 10 is a processing unit. Examples of the processing units include, but are not limited to, a Central Processing Unit (CPU), System-on-a-chip (SoC), a Micro Control Unit (MCU), and a Field-Programmable Gate Array (FPGA). The controller 10 integrally controls the operations of the smartphone 1 to implement various functions.

Specifically, the controller 10 executes instructions contained in the program stored in the storage 9 while referring to the data stored in the storage 9 as necessary. The controller 10 controls a function unit according to the data and the instructions to thereby implement the various functions. Examples of the function units include, but are not limited to, the display 2A, the communication unit 6, and the receiver 7. The controller 10 can change the control of the function unit according to the detection result of a detector. Examples of the detectors include, but are not limited to, the touch screen 2B, the button 3, the illumination sensor 4, the proximity sensor 5, the microphone 8, the camera 12, the camera 13, the acceleration sensor 15, the direction sensor 16, and the gyroscope 17.

The controller 10 executes, for example, the control program 9A to perform various controls, such as a control for changing information displayed on the display 2A in accordance with the gesture detected through the touch screen 2B.

The camera 12 is an in-camera for photographing an object facing the front face 1A. The camera 13 is an out-camera for photographing an object facing the back face 1B.

The connector 14 is a terminal to which other device is connected. The connector 14 may be a general-purpose terminal such as a Universal Serial Bus (USB), a High-Definition Multimedia Interface (HDMI), Light Peak (Thunderbolt), and an earphone/microphone connector. The connector 14 may be a dedicated terminal such as a dock connector. Examples of the devices connected to the connector 14 include, but are not limited to, an external storage device, a speaker, and a communication device.

The acceleration sensor 15 detects a direction and a magnitude of acceleration applied to the smartphone 1. The direction sensor 16 detects a direction of geomagnetism. The gyroscope 17 detects an angle and an angular velocity of the smartphone 1. The detection results of the acceleration sensor 15, the direction sensor 16, and the gyroscope 17 are used in combination with each other in order to detect a position of the smartphone 1 and a change of its attitude.

Part or all of the programs and the data stored in the storage 9 in FIG. 5 may be downloaded from any other device through communication by the communication unit 6. Part or all of the programs and the data stored in the storage 9 in FIG. 5 may be stored in the non-transitory storage medium that can be read by the reader included in the storage 9. Part or all of the programs and the data stored in the storage 9 in FIG. 5 may be stored in the non-transitory storage medium that can be read by a reader connected to the connector 14. Examples of the non-transitory storage mediums include, but are not limited to, an optical disc such as CD, DVD, and Blu-ray, a magneto-optical disc, magnetic storage medium, a memory card, and solid-state storage medium.

The configuration of the smartphone 1 illustrated in FIG. 5 is only an example, and therefore it can be modified as required within a scope that does not depart from the gist of the present invention. For example, the number and the type of the button 3 are not limited to the example of FIG. 5. The smartphone 1 may be provided with buttons of a numeric keypad layout or a QWERTY layout and so on as buttons for operation of the screen instead of the buttons 3A to 3C. The smartphone 1 may be provided with only one button to operate the screen, or with no button. In the example of FIG. 5, the smartphone 1 is provided with two cameras; however, the smartphone 1 may be provided with only one camera or with no camera. In the example of FIG. 5, the smartphone 1 is provided with three types of sensors in order to detect its position and attitude; however, the smartphone 1 does not have to be provided with some of the sensors. Alternatively, the smartphone 1 may be provided with any other type of sensor for detecting at least one of the position and the attitude.

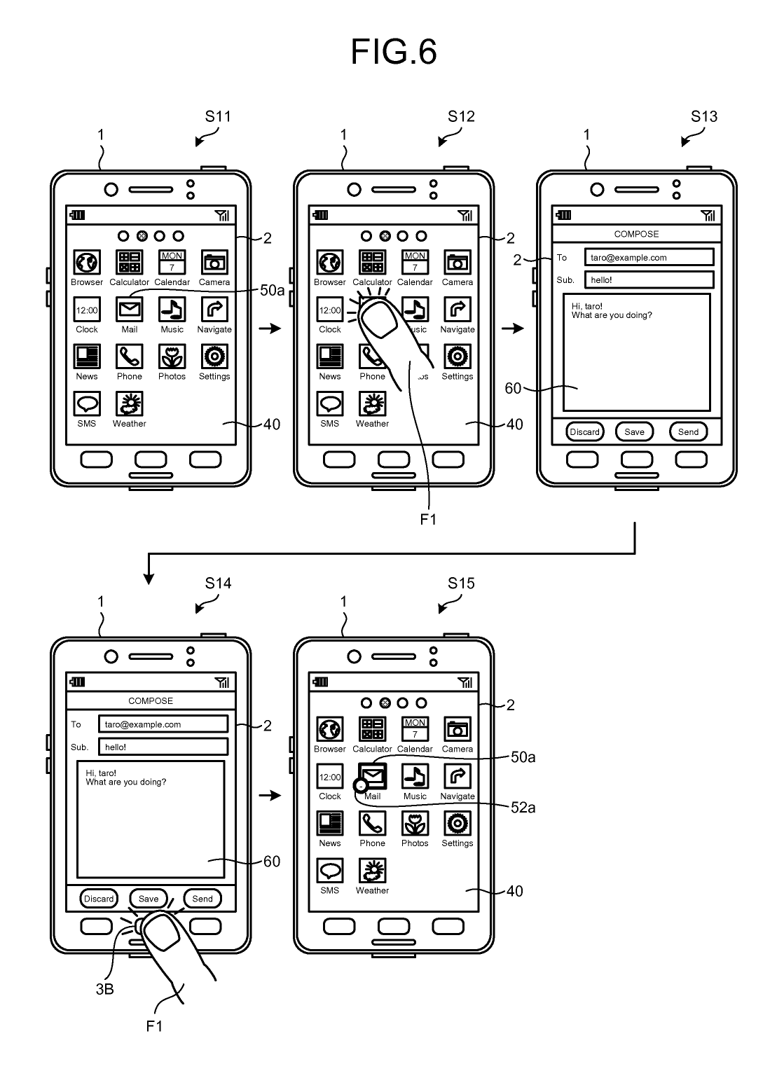

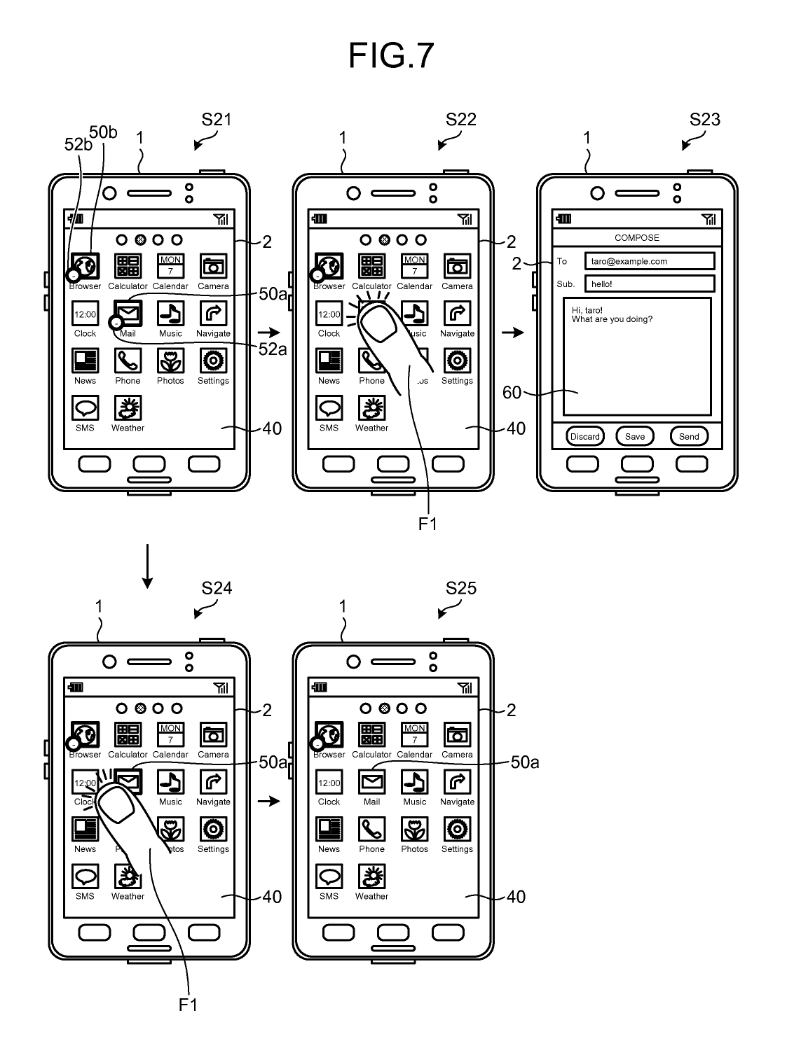

An example of the control based on the function provided by the control program 9A will now be described with reference to FIGS. 6 and 7. FIG. 6 illustrates an example of the control for executing the application in the background. At Step S11 of FIG. 6, the home screen 40 illustrated in FIG. 4 is displayed on the display 2A. At Step S12, a user taps on an icon 50a arranged on the home screen 40 using a finger F1.

When detecting the tap on the icon 50a, the smartphone 1 executes the application corresponding to the icon 50a in the foreground. Execution of the application in the foreground implies that the screen provided by the application is displayed on the display 2A, and that an operation for the screen is managed as an input for the application.

The icon 50a corresponds to the mail application 9B. When the tap on the icon 50a is detected, the smartphone 1 displays the screen provided by the mail application 9B on the display 2A. The screen provided by the mail application 9B is, for example, a mail composition screen 60 illustrated at Step S13. The user inputs a destination mail address, subject, and text, through operations onto the mail composition screen 60.

When the user intends to execute another application during the operation for the mail composition screen 60, he/she presses the button 3B, as illustrated at Step S14. When the button 3B is pressed, the smartphone 1 executes the application being executed in the foreground, in the background. Execution of the application in the background implies that the screen provided by the application is not displayed on the display 2A, and that the operation for the screen is not managed as an input for the application. The application being executed in the background may suspend the process, or may continuously execute a process that can be performed without displaying a screen such as data communication and music reproduction.

At Step S15 illustrated in FIG. 6, because the button 3B is pressed while the mail composition screen 60 is displayed, the smartphone 1 executes the mail application 9B in the background. Then, the smartphone 1 displays the home screen 40, in place of the mail composition screen 60, on the display 2A.

At Step S15, the smartphone 1 displays the icon 50a corresponding to the mail application 9B in a mode different from the case of Step S11. For example, the smartphone 1 has a change in at least one of a frame thickness and a frame color of the icon 50a, from those of Step S11. Thus, when the home screen 40 is displayed, the smartphone 1 makes a change in the display mode of the icon 50 corresponding to the application executed in the background, from the normal mode. As a result, the user can easily understand which application is being executed in the background.

By understanding which application is being executed in the background, the user can easily recognize the suspended operation. The user can also easily understand how many applications are being executed in the background. That is, the user can briefly understand that to what extent various resources are used by the application being executed in the background and that how much burden is put on the smartphone 1.

At Step S15, the smartphone 1 additionally includes a stop button 52a onto the icon 50a. The stop button 52a is used for ending the mail application 9B being executed in the background. The stop button 52a will more specifically be described later with reference to FIG. 7.

The operation for switching the execution of the application in the foreground to the execution in the background is not limited to the operation of pressing the button 3B. For example, when the button 3 other than the button 3B is pressed, or when a predetermined gesture on the touch screen 2B is detected, the smartphone 1 may switch the execution of the application in the foreground to the execution in the background.

FIG. 7 illustrates an example of the control regarding the application being executed in the background. Step S21 illustrated in FIG. 7 illustrates a scene in which the browser application 9C which has been activated through the tapping on the icon 50b is executed in the background, after the scene of Step S15 of FIG. 6. Thus, at Step S21, the display mode of the icon 50b differs from the normal mode. Further, the stop button 52b is added onto the icon 50b.

In this state, as illustrated at Step S22, the user taps on the icon 50a. In this case, the smartphone 1 executes the mail application 9B being executed in the background in the foreground, as illustrated at Step S23, and displays the mail composition screen 60 on the display 2A. At Step S23, the scene of Step S13 is reproduced. That is, the mail composition screen 60 in a scene before the mail application 9B is executed in the background is reproduced.

Thus, when the icon 50 corresponding to the application executed in the background is tapped, the smartphone 1 executes the application corresponding to the tapped icon 50 in the foreground. Further, if it's possible, the smartphone 1 reproduces the screen displayed on the display 2A before the application is executed in the background. In accordance with this control, the user can easily resume the suspended operation.

If a process for data communication or music reproduction continues during the execution in the background, the smartphone 1 may display a screen according to the progress of the process on the display 2A, when the application is executed in the foreground. Alternatively, if the screen cannot be reproduced for the reason of resource shortage or the like, the smartphone 1 may display a new screen on the display 2A when the application is executed in the foreground.

In the state of Step S21 of FIG. 7, as illustrated at Step S24, let it be assumed that the user taps on the stop button 52a added onto the icon 50a. In this case, the smartphone 1 terminates (ends, stops) the mail application 9B corresponding to the tapped stop button 52a. As illustrated at Step S25, the smartphone 1 then deletes the tapped stop button 52a, and restores the icon 50a having the stop button 52a added thereonto into its normal display mode.

Thus, the smartphone 1 terminates the application executed in the background, when the stop button added onto the icon 50 corresponding to the application is tapped. In accordance with this control, the user can easily terminate the application executed in the background. When many applications are executed in the background, the operation of the smartphone 1 may be slow. Therefore, it is very useful that any unnecessary applications can easily be terminated.

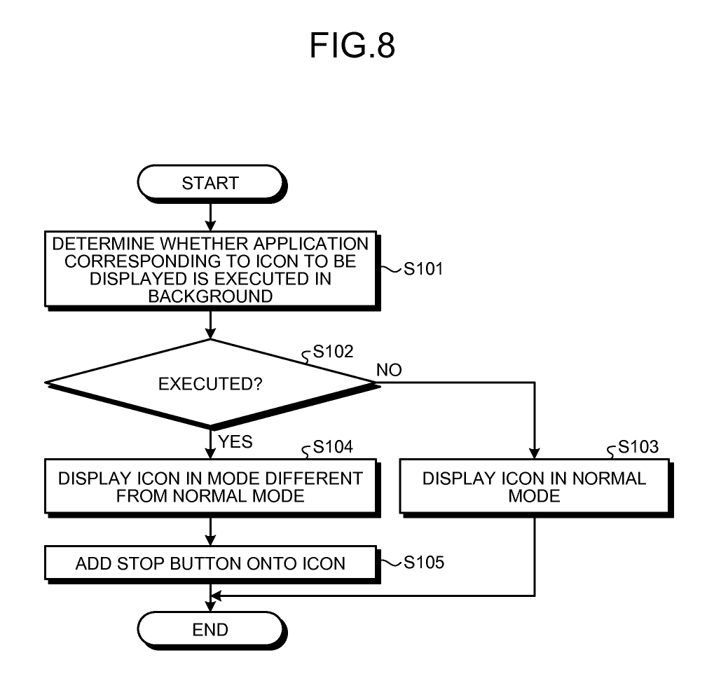

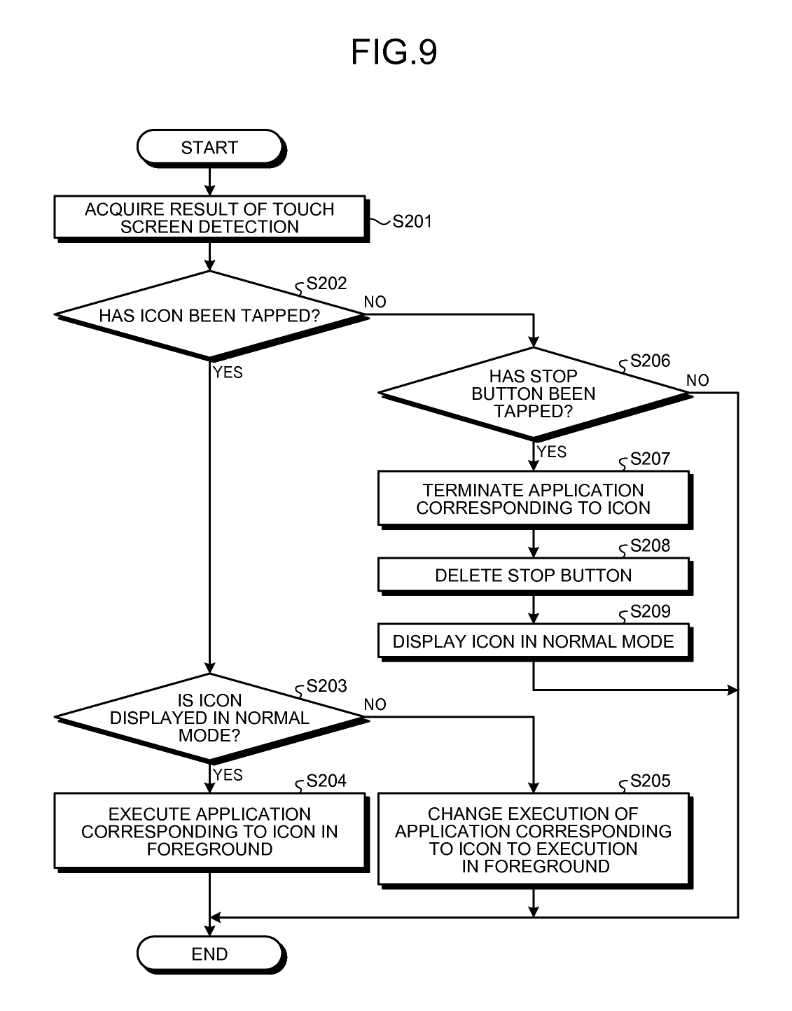

Descriptions will now be made on an example of a process procedure of the control based on a function provided by the control program 9A, with reference to FIGS. 8 and 9. FIG. 8 illustrates a process procedure of an icon display process. The process procedure illustrated in FIG. 8 is realized by the controller 10 executing the control program 9A. The process procedure illustrated in FIG. 8 is executed for each icon 50 arranged in the home screen 40 when the home screen 40 is displayed.

The controller 10 determines whether the application corresponding to the icon to be displayed is executed in the background, at Step S101. A determination as to whether the application corresponding to the icon to be displayed is executed in the background is made based on, for example, the contents of a table for managing conditions of the application being executed.

When the application corresponding to the icon to be displayed is not executed in the background (“No” at Step S102), the controller 10 displays the icon in a normal mode, at Step S103. On the contrary, when the application corresponding to the icon to be displayed is executed in the background (“Yes” at Step S102), the controller 10 displays the icon in a mode different from the normal mode, at Step S104. Then, the controller 10 adds a stop button onto the icon, at Step S105.

FIG. 9 illustrates a process procedure of an application control process. The process procedure illustrated in FIG. 9 is realized by the controller 10 executing the control program 9A. The process procedure illustrated in FIG. 9 is executed every time a gesture is detected through the touch screen 2B while the home screen 40 is displayed.

The controller 10 acquires a detection result of the touch screen 2B, at Step S201. The controller 10 determines whether the gesture detected through the touch screen 2B is a tap on the icon 50, at Step S202. When the detected gesture is the tap on the icon 50 (“Yes” at Step S202), the controller 10 determines whether the icon is in a normal display mode, at Step S203.

When the icon 50 is in a normal display mode (“Yes” at Step S203), the controller 10 executes the application corresponding to the icon 50 in the foreground at Step S204. When the icon 50 is not in a normal display mode (“No” at Step S203), the controller 10 changes the application corresponding to the icon 50 from a state of being executed in the background into a state of being executed in the foreground.

The controller 10 may determine whether the application corresponding to the icon 50 is executed in the background, at Step S203. In this case, when the application corresponding to the icon 50 is not executed in the background, the controller 10 executes Step S204. When the application corresponding to the icon 50 is executed in the background, the controller 10 executes Step S205.

When the detected gesture is not the tap on the icon (“No” at Step S202), the controller 10 determines whether the gesture detected through the touch screen 2B is a tap on the stop button, at Step S206. When the detected gesture is not the tap on the stop button (“No” at Step S206), the controller 10 does not particularly perform a process, or executes a predetermined process in accordance with the detected gesture. In other words, in this embodiment, no specification is made to the process for the case in which the gesture detected at Step S201 is not the tap on the icon or the stop button.

When the detected gesture is the tap on the stop button (“Yes” at Step S206), the controller 10 terminates the application corresponding to the icon 50 with the stop button added thereto, at Step S207. Then, the controller 10 deletes the stop button at Step S208, and displays the icon 50 in a normal mode at Step S209.

The embodiment disclosed in the present application can be modified without departing the gist and the scope of the invention. Moreover, the embodiments and their modifications disclosed in the present application can be combined with each other if necessary. For example, the embodiment may be modified as follows.

For example, the programs illustrated in FIG. 5 may be divided into a plurality of modules, or may be combined with any other program.

In the above-described embodiment, the descriptions have been made to the example in which the present invention is applied to the device including the touch screen display. However, the application of the present invention is not limited thereto. The present invention may be applied to a device which separately includes a display for displaying an icon and an operation unit for receiving an operation for the icon. For example, the mode of an icon to be displayed on the display may be changed in accordance with whether the corresponding application is executed in the background, and an operation for the icon may be detected using a pointing device, such as a mouse and a touch pad.

In the above-described embodiment, the descriptions have been made to the example in which at least one of the frame thickness and frame color of the icon is changed, to display the icon corresponding to the application executed in the background in a mode different from a normal mode. However, the mode of displaying the icon corresponding to the application executed in the background is not limited thereto.

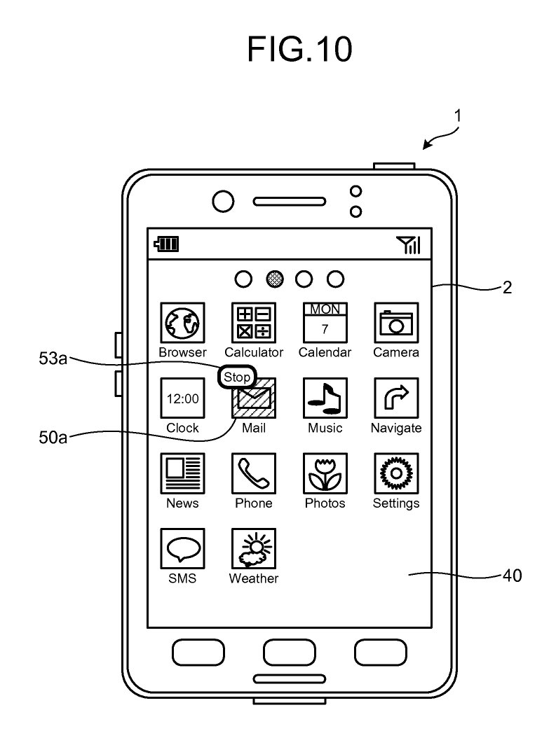

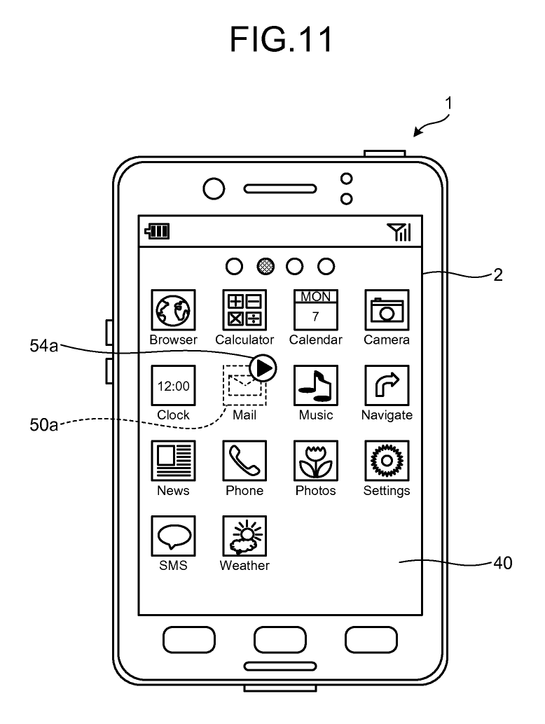

For example, as illustrated in FIGS. 10 and 11, the smartphone 1 may have a change in at least one of the color, brightness, and transparency of the icon corresponding to the application executed in the background. The smartphone 1 may have a change in at least one of the color, brightness, and transparency of the icon corresponding to the application executed in the background, and further may have a change in at least one of the frame thickness and frame color of the icon.

The appearance of the stop button added to the icon corresponding to the application executed in the background is not limited to that of the above-described embodiment. For example, as illustrated in FIG. 10, the smartphone 1 may have a stop button 53a including some letters, such as “Stop” and added onto the icon corresponding to the application executed in the background.

Alternatively, as illustrated in FIG. 11, in the smartphone 1, a resume button 54a may be added onto the icon corresponding to the application being executed in the background, in place of the stop button. In a case where the resume button 54a is added onto the icon 50a, the smartphone 1 executes the application corresponding to the icon 50a in the foreground when the resume button 54a is tapped. When the icon 50a is tapped, the smartphone 1 terminates the application corresponding to the icon 50a. In this way, the operation performed when the icon is tapped and the operation performed when the button added onto the icon is tapped may be switched from those of the above-described embodiment.

In the embodiment, the smartphone has been explained as an example of the device provided with the touch screen display; however, the device according to the appended claims is not limited to the smartphone. The device according to the appended claims may be a mobile electronic device other than the smartphone. Examples of the mobile electronic devices include, but are not limited to, mobile phones, tablets, mobile personal computers, digital cameras, media players, electronic book readers, navigators, and gaming devices. The device according to the appended claims may be a stationary-type electronic device. Examples of the stationary-type electronic devices include, but are not limited to, desktop personal computers, automatic teller machines (ATM), and television receivers.

Although the art of appended claims has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A device comprising:
a display for displaying a home screen in which an icon corresponding to an application to be executed in foreground or background is arranged; and
a controller for controlling the display such that the icon corresponding to the application executed in the background is displayed in a first mode and the icon corresponding to the application not executed in the background is displayed in a second mode.

2. The device according to claim 1, wherein
the controller is configured to change at least one of frame thickness and frame color of the icon from those in the second mode when the icon is displayed on the display in the first mode.

3. The device according to claim 1, wherein
the controller is configured to change at least one of color, brightness, and transparency of the icon from those in the second mode when the icon is displayed on the display in the first mode.

4. The device according to claim 1, wherein
the controller is configured to add a button for terminating the application corresponding to the icon onto the icon when the icon is displayed on the display in the first mode.

5. The device according to claim 4, wherein
the controller is configured to delete the button and display the icon corresponding to the button on the display in the second mode when an operation for the button is performed.

6. The device according to claim 1, wherein
the controller is configured to add a button for executing the application corresponding to the icon in the foreground onto the icon when the icon is displayed on the display in the first mode.

7. The device according to claim 6, wherein
the controller is configured to terminate the application corresponding to the icon displayed in the first mode when an operation for the icon is performed.

8. A method of controlling a device including a display, the method comprising:
executing an application in foreground or background;
displaying an icon corresponding to the application executed in the background on the display in a first mode; and
displaying an icon corresponding to the application not executed in the background on the display in a second mode.

9. A non-transitory storage medium storing therein a program for causing, when executed by a device including a display, the device to execute:
executing an application in foreground or background;
displaying an icon corresponding to the application executed in the background on the display in a first mode; and
displaying an icon corresponding to the application not executed in the background on the display in a second mode.
